(19) United States
(12) Patent Application Publication
(10) Pub. No.: US 2020/0209887 A1
(43) Pub. Date: Jul. 2, 2020

(54) SYSTEM AND METHOD FOR ADJUSTING CONTROL OF AN AUTONOMOUS VEHICLE USING CROWD-SOURCE DATA

(71) Applicant: Robert Bosch GmbH, Stuttgart (DE)

(72) Inventors: Lixiu YU, Pittsburgh, PA (US); Alessandro OLTRAMARI, Pittsburgh, PA (US)

(21) Appl. No.: 16/235,565

(22) Filed: Dec. 28, 2018

(51) Int. Cl. G05D 1/02; G05D 1/00; G01C 21/34

(52) U.S. Cl. CPC G05D 1/0276; G05D 1/0088; G05D 1/0214; G05D 2201/0213; G01C 21/3415; G01C 21/3461; G05D 1/0223

(57) ABSTRACT

A system and method is disclosed for adjusting control of an autonomous vehicle based on crowd-source data. The autonomous vehicle may be designed to receive crowd-source data relating to a driving condition located along a travel route the autonomous vehicle is travelling. The control of the autonomous vehicle may then be adjusted in response to the crowd-source data provided. The autonomous vehicle may also request crowd-source data related to how the autonomous vehicle should proceed along a travel route. Based on the request, the autonomous vehicle may receive crowd-source data instructing the autonomous vehicle how to proceed along the travel route. The autonomous vehicle may also adjust how the autonomous vehicle proceeds along the travel route in response to the crowd-source data.

### TECHNICAL FIELD

The following relates generally to a system and method for adjusting control of an autonomous vehicle using crowd-source data.

### BACKGROUND

To navigate through a neighborhood safely, autonomous vehicles (i.e., self-driving cars) detect road conditions and objects accurately. Current autonomous vehicle systems use sophisticated algorithms that rely on data received from sensors, cameras, global positioning systems, and high-definition (HD) maps to generate an accurate picture of the surrounding environment and its own global position to navigate safely in any environment. Even with sensors currently available, autonomous vehicles may require human assistance from drivers residing within the vehicle or at a command center to properly assess and navigate a given environment. Having a human assistant dedicated to each autonomous vehicle on the road is expensive, unscalable, and unreliable.

### SUMMARY

In one embodiment, a system and method is disclosed for adjusting control of an autonomous vehicle based on crowd-source data. The autonomous vehicle may be designed to receive crowd-source data relating to a driving condition located along a travel route the autonomous vehicle is travelling. The control of the autonomous vehicle may then be adjusted in response to the crowd-source data provided.

One or more sensors may also be used for controlling the autonomous vehicle along the travel route. The autonomous vehicle may adjust the sensitivity of at least one sensor in response to the driving condition indicating an obstacle is located along the travel route. Also, the autonomous vehicle may adjust the vehicle speed in response to the driving condition indicating an obstacle is located along the pre-defined travel route. Lastly, the autonomous vehicle may adjust the pre-defined route to an alternative travel route in response to the driving condition indicating an obstacle is located along the pre-defined travel route.

In another embodiment, a system and method is disclosed for adjusting control of an autonomous vehicle based on crowd-source data. The autonomous vehicle may request crowd-source data related to how the autonomous vehicle should proceed along a pre-defined travel route. Based on the request, the autonomous vehicle may receive crowd-source data instructing the autonomous vehicle how to proceed along the pre-defined travel route. The autonomous vehicle may also adjust how the autonomous vehicle proceeds along the pre-defined route in response to the crowd-source data.

The crowd-source data received by the autonomous vehicle may be obtained from one or more contributors located in relatively close proximity to the autonomous vehicle. The contributors are also incentivized for providing the crowd-source data.

### BRIEF DESCRIPTION OF THE DRAWINGS

FIG. 1 is a block diagram of an autonomous vehicle;

FIG. 2 is a block diagram of an autonomous vehicle; and

FIG. 3 are exemplary screenshots of a mobile application.

### DETAILED DESCRIPTION

As required, detailed embodiments are disclosed herein; however, it is to be understood that the disclosed embodiments are merely exemplary and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present embodiments.

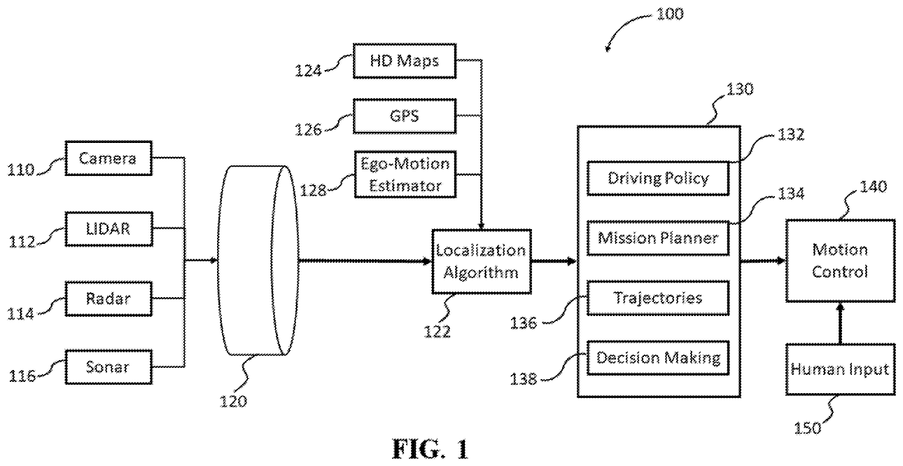

One area of increased interest regarding vehicle mobility is autonomous vehicles—i.e., self-driving cars. To navigate safely, autonomous vehicles should be able to understand and respond to the surrounding environment by detecting road conditions and identifying potential obstacles (e.g., parked cars). For instance, FIG. 1 illustrates a high-level block diagram of an autonomous vehicle 100.

Autonomous vehicle 100 generally includes data collected from sensors, including a camera 110, Light Detection and Ranging (LIDAR) 112, radar 114, and sonar 116. Autonomous vehicle 100 will then use a data fusion perception algorithm to synchronize the data 120 gathered. The data 120 may then be processed using a localization algorithm 122 using high-definition (HD) maps 124, global positioning system (GPS) data 126 and ego-motion estimations 128.

A control algorithm 130 might then receive the data provided by localization algorithm 122. Control algorithm 130 might include a driving policy 132 for following travel segments, a mission planner 134 for creating driving strategies, and a decision-making algorithm 136 for determining how the vehicle should be controlled. It is contemplated that control algorithm 130 may be a machine-learning or artificial intelligence strategy designed to make decisions about how the autonomous vehicle 100 should be operated. Control algorithm 130 may also provide motion control 140 that controls the autonomous vehicle 100 based on the decision-making process employed.

It is contemplated that currently employed sensors 110-116 and control algorithm 130 may have difficulty in navigating the autonomous vehicle 100 around challenging conditions such as icy road surfaces or pot holes. Conditions that include poor lighting, severe weather, and foreign obstacles that appear suddenly (e.g., bicyclists) also may lower the performance of autonomous vehicle 100. Control algorithm 130 may also require large amounts of data to be properly trained.

To assist autonomous vehicle 100 in overcoming the difficulties encountered by control algorithm 130, manufacturers may rely on human drivers—either within the vehicle or located at a remote command center—to assist decisions about how the autonomous vehicle 100 should be controlled. One reason humans may be desired is due to their innate sense perception which includes past driving experiences and knowledge of local surroundings. It is generally understood that human sense perception may assist in safely navigating the autonomous vehicle 100 in a manner that control algorithm 130 cannot provide alone.

For instance, autonomous vehicle 100 may further receive input 150 from a human driver that adjusts motion control 140—e.g., apply the brake to slow down or stop the vehicle. For instance, autonomous vehicle 100 might be driving a certain Pittsburgh roadway that typically may encounter “black ice” conditions during cold, winter mornings. Control algorithm 130, however, might not adjust motion control 140 to slow the autonomous vehicle 100 to account for potential “black ice” conditions because sensors 110-116 do not detect potential, future icy condition. Instead, control algorithm 130 might only adjust motion control 140 to slow the autonomous vehicle 100 after sensors 110-116 have begun proceeding on and detecting icy road conditions due to slippage of the wheels.

Unfortunately, autonomous vehicle 100 may lose control and cause an accident if control algorithm 130 waits to adjust the vehicle speed until after autonomous vehicle 100 has already begun slipping on an icy roadway. Also, a human driver situated at a remote command center in Los Angeles not familiar with “black ice” conditions. As such, a remote human driver might not adjust input 150 until after the autonomous vehicle 100 has already begun slipping on the icy roadway. Similarly, control algorithm 130 and input 150 might not be adjusted if autonomous vehicle 100 is traveling in a given neighborhood where young children typically play or at a given intersection where residents are known to jaywalk. Control algorithm 130 might not be adjusted because local traffic patterns, locations where children play, or even common jaywalking intersections are knowledge that humans learn through past experiences.

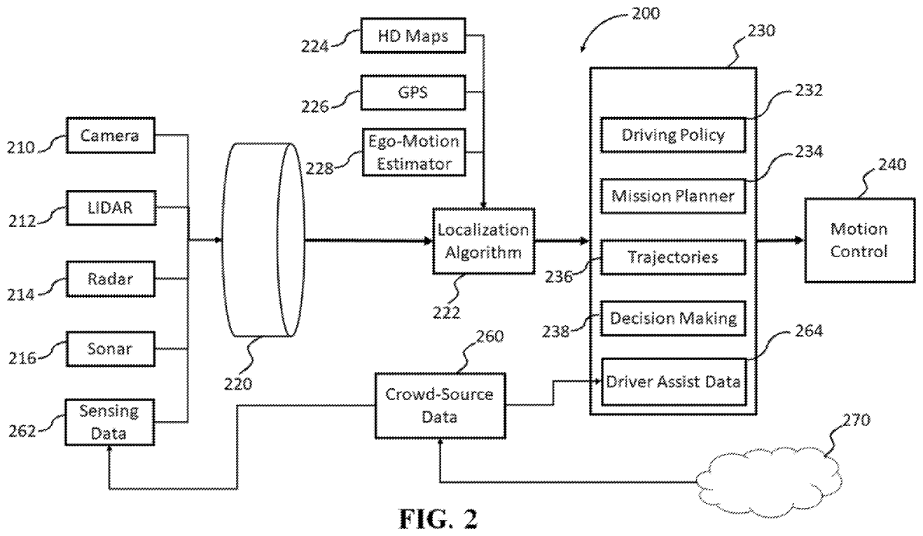

It is therefore contemplated that there exists a need to gather and provide human-knowledge to assist in how autonomous vehicles are controlled. For instance, FIG. 2 illustrates an autonomous vehicle 200 similar to autonomous vehicle 100 described above. As shown, autonomous vehicle 200 includes sensors 210-216 that also undergo a data fusion perception algorithm to form synchronized data 220. Like autonomous vehicle 100, synchronized data 220 uses a localization algorithm 222 using high-definition (HD) maps 224, global positioning system (GPS) data 226 and ego-motion estimations 228.

A control algorithm 230 again receives the data provided by localization algorithm 222. The control algorithm 230 might again include a driving policy 232 for following travel segments, a mission planner 234 for creating driving strategies, and a decision-making algorithm 236 for determining how the vehicle should be controlled. It is again contemplated that control algorithm 230 may be a machine-learning or artificial intelligence algorithm. Lastly, control algorithm 230 may provide motion control output 240 that control the autonomous vehicle 200.

Autonomous vehicle 200 further receives crowd-source data 260 that might include sensing data 262 or driver assist data 264. A server 270 may operate to collect, organize, and share the crowd-source data 260 with the autonomous vehicle 200. It is contemplated that server 270 may operate as a crowd-source repository that collects crowd-source data 260 from individuals through a website interface or mobile application (app). Stated differently, server 270 may acquire crowd-sourced data contributed by many different individual contributors. It is contemplated that server 270 can have any number of different contributors providing the crowd-sourced data 260. The contributors may be self-motivated or compensated, as discussed below. It is contemplated the contributors are knowledgeable about a given location and conditions that could affect how control algorithm 230 needs to control the autonomous vehicle 200.

It is also contemplated that server 270 may be situated anywhere worldwide, but server 270 could provide crowd-source data 260 specific to where autonomous vehicle 200 is currently located. It is further contemplated that autonomous vehicle 200 may receive crowd-source data 260 via wireless transmission on a real-time basis or as part of regularly scheduled updates to control algorithm 230.

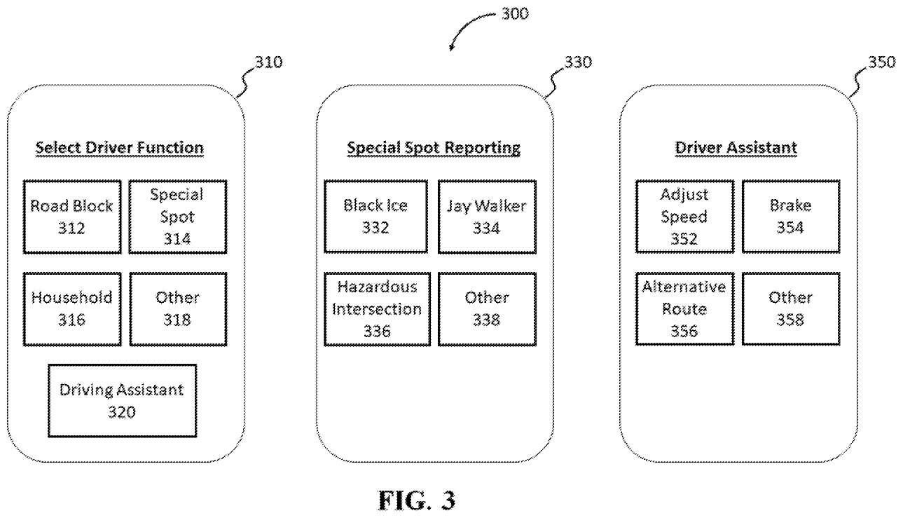

FIG. 3 illustrates several exemplary screen shots of a mobile app 300 that could be used provide server 270 with crowd-source data 260. It is contemplated that mobile app 300 could prompt a user for which geo-graphic location they wish to provide crowd-source data 260 about, or mobile app 300 could rely on a device's internally stored geo-graphic location.

Mobile app 300 may also provide screen 310 that includes several soft buttons 312-328 that a contributor may select. For instance, soft button 312 may allow a contributor to provide real-time road block information to server 270 that may include on-going construction work, current traffic accident, or public events. Autonomous vehicle 200 may then receive the real-time road block information as part of the crowd-source data 260 provided by server 270.

Mobile app 300 may also allow contributors the capability of identifying potential geo-graphic location that might include a hazardous road condition or a geo-graphic location where moving obstacles or obstructions might occur. For instance, by selecting soft button 314 a contributor may be provided screen 330 that includes soft button 332-338 allowing a contributor to report input road conditions near or at the autonomous vehicle's current location. Contributor can select soft button 332 to report information related to a hazardous road condition, e.g., black ice on a given road. It is contemplated that mobile app 300 may allow contributor to provide hazardous road conditions for other types of weather conditions (e.g., flooded roads, icy bridge conditions) or for obstacles that may block a given roadway (e.g., downed power lines, fallen trees or branches).

Contributor can also select soft button 334 to report information about intersections where people are known to jaywalk. Contributor can further select soft button 336 to report information about hazardous intersections, including streets where children are known to play or intersections prone to accidents because of blocked visibility. However, soft buttons 332-338 are merely exemplary and the mobile app 300 may be designed to allow contributor to report any type of crowd-source data 260 that may be used to provide advanced warning to control algorithm 230.

The crowd-source data 260 provided using screen 330 may be provided to autonomous vehicle 200 as a sensing data 262 that is incorporated within the data fusion perception algorithm that generates synchronized data 220. The control algorithm 230 can then use sensing data 262 to either adjust the speed level of the autonomous vehicle 200 (e.g., from 35 M.P.H. to 25 M.P.H.) or to alter the route taken by the autonomous vehicle 200. But, it is further contemplated that control algorithm 230 may use sensing data 262 to alter the motion control output 240 in other manners. For instance, the control algorithm 230 may alter motion control output 240 to have autonomous vehicle 200 proceed more slowly through an intersection identified by a contributor as having blocked visibility.

Crowd-source data 260 may also be used by control algorithm 230 to alter the sensitivity level or range setting of sensors 210-216. For instance, for crowd-source data 260 may indicate children are known to play in the front yard on a given street. Based on the crowd-source data 260, control algorithm 230 may alter camera 210 or LIDAR 212 sensitivity to have a broader scanning range. The broader scanning range might be used to detect a greater degree on both sides and ahead of the autonomous vehicle 200. By controlling the sensitivity and range of sensors 210-216, control algorithm 230 might be able to have advanced detection of where children are located with respect to autonomous vehicle 200. By monitoring the location of the children, control algorithm 230 could ensure enough response time to slow or stop autonomous vehicle 200 if a child begins to run toward the path of the autonomous vehicle 200.

Alternatively, by selecting soft button 320 contributor may be provided driving assistant screen 350. Contributor may use the driving assistant screen 350 to assist control algorithm 230 in deciding how to operate autonomous vehicle 200. For instance, autonomous vehicle 200 may encounter a roadway that is partially blocked by a parked semi-truck. As a result, control algorithm 230 may not be able determine whether to pass around the parked semi-truck or to proceed down an alternative route. Control algorithm 230 may send a signal to server 270 requesting assistance from a contributor. A Contributor located in-close proximity to autonomous vehicle 200 may receive the assistance request via the mobile app 300. Contributors may use the driving assistant screen 350 to provide crowd-source data 260 related to driver assist data 264. For instance, the driving assistant screen 350 may allow a contributor to provide control algorithm 230 with instructions about how to proceed around the obstacle blocking the road—e.g., the parked semi-truck. Or contributor may be able to provide driver assist data 264 informing control algorithm 230 to proceed down an alternative route using soft button 356. It is further contemplated that mobile app 300 may allow a contributor the capability of instructing the control algorithm 230 to adjust the vehicle speed (e.g., using soft button 352) or to apply braking (e.g., using soft button 354).

It is contemplated that mobile app 300 is meant to allow contributors the capability to provide crowd-source data 260 (e.g., sensing data 262 or driver assist data 264) to server 270. Autonomous vehicle 200 would need to connect and request the crowd-source data 260 from the server 270. The crowd-source data 260 provided by server would also be specific to the geo-graphic location of autonomous vehicle 200. It is also contemplated that contributors providing the crowd-source data 260 are located in relative proximity to the autonomous vehicle 200. For instance, it is contemplated that the crowd-source data 260 gathered by server 270 will be provided by contributors located within a given distance from autonomous vehicle 200.

It also contemplated that the autonomous vehicle 200 may include a single controller that may request and receive crowd-source data 260 from server 270 and then use the crowd-source data 260 to adjust the control algorithm 230. It is also contemplated that a separate transceiver may be used to request and receive crowd-source data 260 from server 270. The transceiver may then transmit the crowd-source data 260 to a vehicle controller located elsewhere in autonomous vehicle 200. The vehicle controller may then use the crowd-source data 260 to adjust the control algorithm 230.

It is further contemplated that contributors could be incentivized for providing crowd-source data 260. For instance, a contributor that provides crowd-source data 260 may be given discounts on ride-sharing services (e.g., Uber) or at local retail shops. Or, contributors may be incentivized in the form of monetary payments for providing crowd-source data 260. Contributors owning an autonomous vehicle may also be given partial or complete access to the crowd-source data 260 collected and stored by server 270. By providing contributors with incentives or free access to the crowd-source data 260, a collective contributor knowledgebase can be established. The collective knowledgebase may be used by autonomous vehicle to ensure safe driving and reduce potential accidents. The collective knowledgebase may also be used to improve route selection by the autonomous vehicle.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data, logic, and instructions executable by a controller or computer in many forms including, but not limited to, information permanently stored on non-writable storage media such as random operating memory (ROM) devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for adjusting control of an autonomous vehicle, comprising:
receiving crowd-source data relating to a driving condition located along a travel route of the autonomous vehicle; and
adjusting how the autonomous vehicle is controlled in response to the crowd-source data.

2. The method of claim 1 further comprising: adjusting a sensitivity level of at least one sensor used to control the autonomous vehicle in response to the driving condition indicating an obstacle is located along the travel route.

3. The method of claim 1 further comprising: adjusting a speed level of the autonomous vehicle in response to the driving condition indicating an obstacle is located along the travel route.

4. The method of claim 1 further comprising: adjusting the travel route of the autonomous vehicle to an alternative travel route in response to the driving condition indicating an obstacle is located along the travel route.

5. The method of claim 1, further comprising: determining a geo-graphic location of the autonomous vehicle; and providing crowd-source data specific to the geo-graphic location of the autonomous vehicle.

6. The method of claim 1, wherein the driving condition includes a hazardous road condition.

7. The method of claim 1, wherein the driving condition includes a section of road where at least one sensor used to control the autonomous vehicle would have reduced visibility.

8. The method of claim 1, wherein the driving condition includes a moving obstacle that is not detectible by at least one sensor used to control the autonomous vehicle.

9. The method of claim 1 further comprising: obtaining the crowd-source data from one or more contributors located in relative proximity to the autonomous vehicle.

10. The method of claim 9, wherein the one or more contributors are incentivized for providing the crowd-source data.

11. A method for adjusting control of an autonomous vehicle, comprising:
requesting crowd-source data related to how the autonomous vehicle should proceed along a travel route;
receiving crowd-source data instructing the autonomous vehicle how to proceed along the travel route; and
adjusting control of the autonomous vehicle in response to the crowd-source data.

12. The method of claim 11, wherein the crowd-source data instructs the autonomous vehicle to proceed along an alternate travel route.

13. The method of claim 11, wherein the crowd-source data instructs the autonomous vehicle to adjust a vehicle speed while traveling along the travel route.

14. The method of claim 11 further comprising: obtaining the crowd-source data from one or more contributors located in relative proximity to the autonomous vehicle.

15. The method of claim 14, wherein the one or more contributors are incentivized for providing the crowd-source data.

16. The method of claim 11, wherein the crowd-source data further includes information relating to a driving condition located along a route the autonomous vehicle is travelling.

17. The method of claim 16 further comprising: adjusting how the autonomous vehicle is controlled in response to the information relating to the driving condition.

18. An autonomous vehicle system, comprising:
a communication module configured to receive crowd-source data relating to a driving condition located along a travel route of an autonomous vehicle; and
a controller configured to adjust how the autonomous vehicle is controlled in response to the crowd-source data.

19. The autonomous vehicle system of claim 18 further comprising: at least one sensor configured to control the autonomous vehicle; and the controller configured to adjust a sensitivity level of the at least one sensor in response to the driving condition indicating an obstacle being located along the travel route.

20. The autonomous vehicle system of claim 18, wherein the controller is further configured to adjust a speed level of the autonomous vehicle in response to the driving condition indicating an obstacle being located along the travel route.
